(19) United States
(12) Patent Application Publication
(10) Pub. No.: US 2019/0187404 A1
(43) Pub. Date: Jun. 20, 2019

(54) IMAGING DEVICE AND SURVEILLANCE CAMERA HAVING THE IMAGING DEVICE

(71) Applicant: CANON KABUSHIKI KAISHA, Tokyo (JP)

(72) Inventor: Tomoya Onaka, Tokyo (JP)

(21) Appl. No.: 16/214,323

(22) Filed: Dec. 10, 2018

(30) Foreign Application Priority Data
Dec. 19, 2017 (JP) 2017-242919

(51) Int. Cl. G02B 7/04

(52) U.S. Cl. CPC G02B 7/04

(57) ABSTRACT

An imaging device according one embodiment of the present invention has: a second group lens barrel having a second group lens and movable in an optical axis A direction of an imaging optical system; a first actuator engaged with the second group lens barrel via an actuator coupling portion to move the second group lens barrel in the optical axis A direction; a cam cylinder rotatable about an rotation axis B parallel to the optical axis A; a first cam follower provided to the second group lens barrel and engaged with a second group cam groove of a cam cylinder; a second cam follower coupled so as to be relatively movable via a second group rack member and engaged with the second group cam groove; and a rack spring that actuates the second cam follower to the cam cylinder and actuates the actuator coupling portion toward the first actuator.

### BACKGROUND OF THE INVENTION

### Field of the Invention

The present invention relates to an imaging device and a surveillance camera having the imaging device.

### Description of the Related Art

Some imaging devices are configured to perform zooming by linearly moving a lens holding frame in the optical axis direction by a linear actuator to rotate a cam cylinder by using a cam follower attached to the lens holding frame and linearly moving another lens holding frame via the cam cylinder in the optical axis direction. In an imaging device with such a configuration, it is required to reduce backlash of the cam follower to the cam cylinder and to reduce backlash of the lens holding frame to the linear actuator.

Japanese Patent No. 5677039 discloses a configuration in which a cam follower is pressed against one surface of one cam groove by an actuation member, and a cam follower attached to the actuation member is pressed against the other surface of the one cam groove in order to reduce backlash of the lens holding frame to the cam cylinder. Japanese Patent No. 2725491 discloses a configuration in which a recess and a protrusion on the lens holding frame is engaged with a protrusion and a recess of the mounting portion of the linear actuator by the actuation member in order to remove backlash of the lens holding frame to the linear actuator.

If the configurations disclosed in Japanese Patent No. 5677039 and Japanese Patent No. 2725491 are combined in order to reduce backlash of the cam follower to the cam cylinder and backlash of the lens holding frame to the linear actuator, however, such a combination will result in a configuration in which a plurality of actuation members are located at different places. Therefore, a larger number of components are required. Further, a friction loss due to unnecessary force occurs, and a load is applied to the actuator. In view of the circumstances described above, the problem to be solved by the present invention is to provide an imaging device that can reduce the number of components and reduce the load applied to the actuator.

### SUMMARY OF THE INVENTION

In order to achieve the objective described above, the present invention provides an imaging device having an imaging optical system having an optical member, and the imaging device includes: an optical member-holding member that holds the optical member and is movable in an optical axis direction of the imaging optical system; a coupling portion coupled to the optical member-holding member so as to be relatively movable with respect to the optical member-holding member; a drive portion that moves the optical member-holding member in the optical axis direction via the coupling portion; a cam cylinder that is rotatable about an axis line parallel to the optical axis; a first cam follower provided to the optical member-holding member and engaged with a cam groove provided to the cam cylinder; a second cam follower attached to the coupling portion and engaged with the cam groove provided to the cam cylinder; and an actuation member that actuates the second cam follower to an inner peripheral surface of the cam groove of the cam cylinder and actuates the coupling portion toward the drive portion.

Further features of the present invention will become apparent from the following description of exemplary embodiments with reference to the attached drawings.

### BRIEF DESCRIPTION OF THE DRAWINGS

FIG. 1 is a perspective exploded view schematically illustrating a configuration example of an imaging device.

FIG. 2 is a perspective external view schematically illustrating a configuration example of the imaging device.

FIG. 3 is a sectional view schematically illustrating a configuration example of the imaging device.

FIG. 4 is a perspective exploded view schematically illustrating a configuration example of an optical filter unit.

FIG. 5 is an expansion view schematically illustrating a configuration example of a cam groove.

FIG. 6 is a sectional view schematically illustrating a configuration example of the imaging device.

FIG. 7 is a diagram schematically illustrating a configuration example of a second group lens barrel and a second group rack member.

FIG. 8 is a perspective view schematically illustrating a configuration example of the second group lens barrel and the second group rack member.

FIGS. 9A, 9B, 9C, 9D, 9E, and 9F are diagrams schematically illustrating a configuration example of the second group lens barrel and the second group rack member.

FIG. 10 is a perspective view schematically illustrating a configuration example of the second group lens barrel and the second group rack member.

FIGS. 11A, 11B, 11C, 11D, 11E, and 11F are diagrams schematically illustrating a configuration example of the second group lens barrel and the second group rack member.

FIG. 12 is a sectional view schematically illustrating a configuration example of a surveillance camera.

### DESCRIPTION OF THE EMBODIMENTS

Each embodiment of the present invention will be described below in detail with reference to the attached diagrams. Each direction in three-dimensional directions of an imaging device is indicated by an X-direction, a Y-direction, and a Z-direction in each drawing. The X-direction is the optical axis direction of an imaging optical system of the imaging device. The Y-direction and the Z-direction are perpendicular to the imaging optical system of the imaging device and are orthogonal to each other.

Imaging Device

### First Embodiment

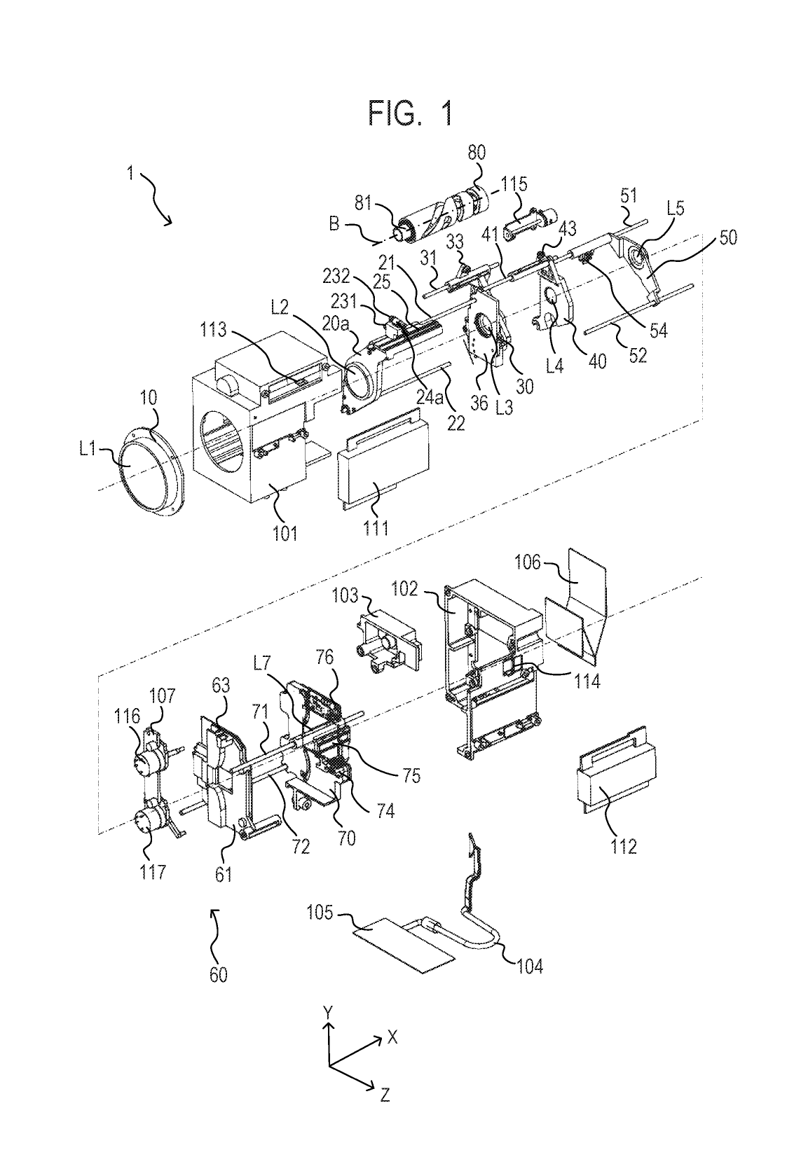

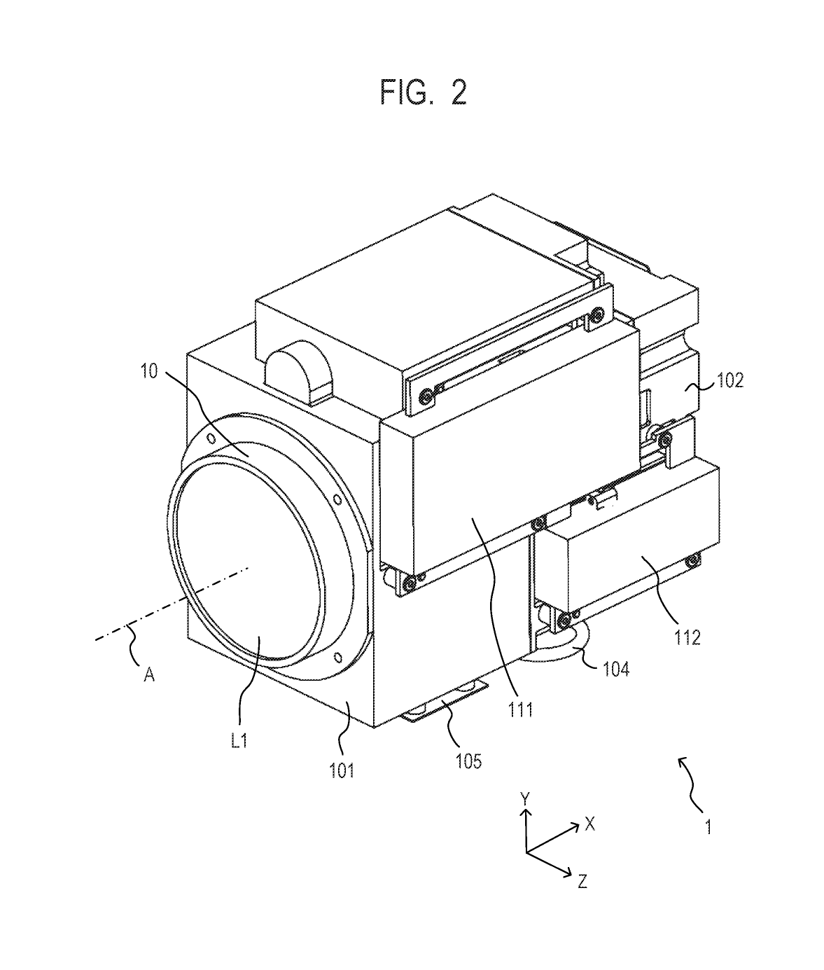

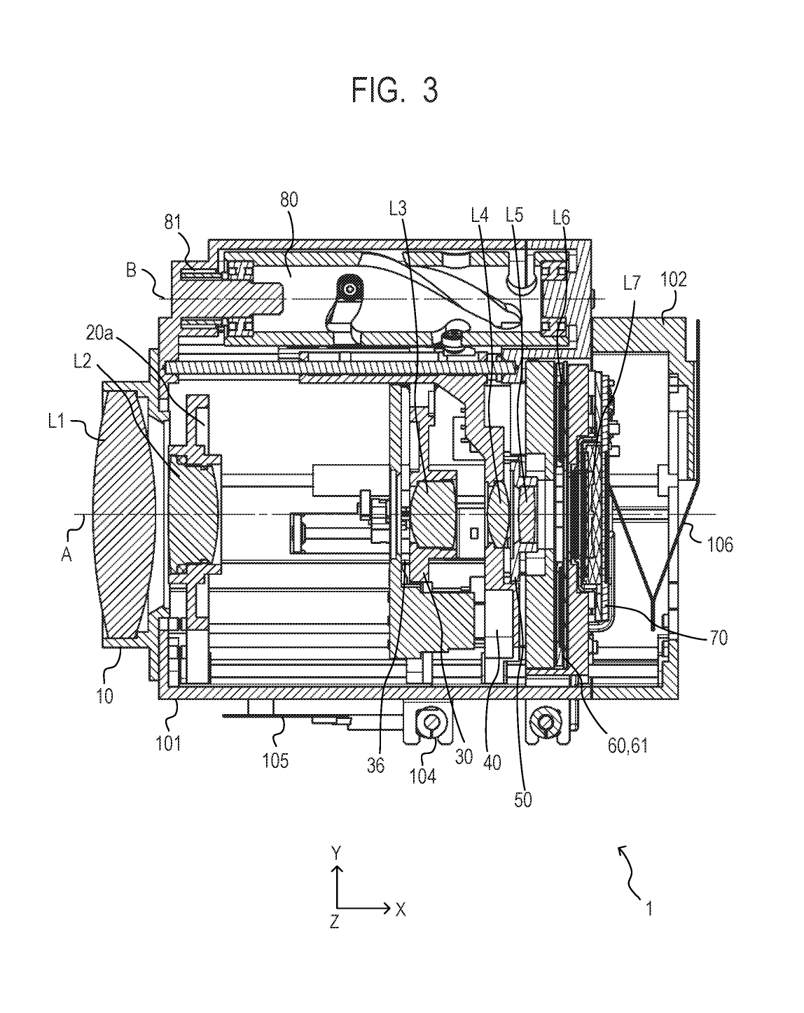

FIG. 1 is a perspective exploded view schematically illustrating a configuration example of an imaging device 1 according to a first embodiment. FIG. 2 is a perspective external view schematically illustrating a configuration example of the imaging device 1 according to the first embodiment. FIG. 3 is a sectional view schematically illustrating a configuration example of the imaging device 1 according to the first embodiment. As illustrated in FIG. 1 to FIG. 3, the imaging device 1 according to the embodiment of the present invention has an imaging optical system. Further, the imaging device 1 has a fixed lens barrel 101 and a rear lens barrel 102 that have a function as a casing. The fixed lens barrel 101, which is arranged on the front side of the imaging device 1 (the side facing an object), and the rear lens barrel 102, which is arranged on the rear side (the side opposite to the side facing an object), are fixed to each other by a screw or the like.

The imaging optical system of the imaging device 1 has a first group lens L1, a second group lens L2, a third group lens L3, a fourth group lens L4, and a fifth group lens L5. Further, these lenses of each group are arranged in the order described above from the side facing an object. The first group lens L1 is fixed so as not to move in the direction of an optical axis A. The second group lens L2, the third group lens L3, and the fourth group lens L4 are zooming lenses related to a zooming operation (zooming) and perform zooming when moving in the optical axis A direction of the imaging optical system. The fifth group lens L5 is a focus lens related to a focusing operation (focusing) and performs a focusing operation (focusing) when moving in the optical axis A direction of the imaging optical system.

In addition, the imaging optical system of the imaging device 1 has an optical filter unit 60, an aperture unit 36, and an image pickup device L7. The optical filter unit 60 has a removable optical filter L6 on an optical path of the imaging optical system and transmits or shields a light beam in a specific wavelength range. The aperture unit 36 changes an aperture diameter by driving an aperture blade and adjusts the amount of light passing through the imaging optical system (entering the image pickup device L7). A photoelectric conversion device such as a CCD sensor, a CMOS sensor, or the like can be applied to the image pickup device L7.

The first group lens L1 is held in a first group lens barrel 10. The first group lens barrel 10 is a member that holds the first group lens L1 and is fixed to the fixed lens barrel 101 having a function of the casing of the imaging device 1.

The second group lens L2, which is an example of an optical member, is held in a second group lens barrel 20a, which is an example of an optical member-holding member. The second group lens barrel 20a, which is an example of the optical member-holding member, is a member that holds a second guide bar of the second group lens L2, which is an example of the optical member, and is arranged so as to be movable in the optical axis A direction. In the present embodiment, the second group lens barrel 20a is guided (supported) so as to be movable in the optical axis A direction, and the rotation is restricted by a first guide bar 21 and a second guide bar 22, which are examples of a guide member.

The first guide bar 21 and the second guide bar 22 are bar-shaped members parallel to each other and extend in the optical axis A direction. The second group lens barrel 20a is provided with a sleeve portion and an engagement groove that is substantially U-shaped when viewed in the optical axis A direction. The first guide bar 21 is then inserted through the sleeve portion. Thereby, the second group lens barrel 20a is guided (supported) by the first guide bar 21 so as to be movable in the optical axis A direction, and the second guide bar 22 is engaged (interlocked) with the engagement groove. Thereby, the rotation about the first guide bar 21 of the second group lens barrel 20a is restricted.

Further, to the second group lens barrel 20a, a first cam follower 231 is attached and a second cam follower 232 is coupled via a second group rack member 24a, which is an example of a coupling portion. The first cam follower 231 is rotatable, and the rotation center line 261 thereof is perpendicular to the optical axis A. The second group rack member 24a, which is an example of the coupling portion, is a member that supports the second cam follower 232 and transmits drive force of a first actuator 111, which is an example of a drive portion, to the second group lens barrel 20a.

Further, the second group rack member 24a is a member that supports the second cam follower 232 so as to be rotatable. The second group rack member 24a is coupled to the second group lens barrel 20a so as to be relatively displaceable. In particular, the second group rack member 24a is able to move with respect to the second group lens barrel 20a in the direction (±Z-direction) of approaching or separating from the first actuator 111 and in the circumferential direction (tangential direction of the circle) of a cam cylinder 80. The second cam follower 232 is attached to the second group rack member 24a so as to be rotatable. The rotation center line 262 of the second cam follower 232 is perpendicular to the optical axis A. Further, each of the first cam follower 231 and the second cam follower 232 is engaged (interlocked) with a second group cam groove 82 (that is, the same cam groove) provided in the cam cylinder 80 described later. Note that a configuration of the first cam follower 231, the second group rack member 24a, and the second cam follower 232 will be described later.

In addition, a second group position detection scale 25 for detecting a position of the second group lens barrel 20a in the optical axis A direction is fixed to the second group lens barrel 20a. Further, a second group position sensor 113 that can detect the second group position detection scale 25 is fixed to the fixed lens barrel 101. It is possible to detect the position of the second group lens barrel 20a in the optical axis A direction by detecting the second group position detection scale 25 by using the second group position sensor 113. On the second group position detection scale 25, a periodic light and dark pattern is provided in parallel to the optical axis A direction, for example. Further, an optical sensor having a light emitting portion and a light receiving portion can be applied to the second group position sensor 113. Further, the second group position sensor 113 detects a light reflected by the light and dark pattern of the second group position detection scale 25 attached to the second group lens barrel 20a for conversion to an electric signal, and thereby the position of the second group lens barrel 20a in the optical axis A direction can be detected.

The third group lens L3 is held in a third group lens barrel 30. The third group lens barrel 30 is a member that holds the third group lens L3 and is arranged so as to be movable in the optical axis A direction. The third group lens barrel 30 is guided (supported) so as to be movable in the optical axis A direction, and the rotation is restricted by a bar-shaped third guide bar 31 and the second guide bar 22 that are parallel to each other and extend in the optical axis A direction.

Specifically, the third group lens barrel 30 is provided with a sleeve portion and an engagement groove that is substantially U-shaped when viewed in the optical axis A direction. Further, the third guide bar 31 is inserted through the sleeve portion, and thereby the third group lens barrel 30 is supported (guided) so as to be movable in the optical axis A direction. Further, since the second guide bar 22 is engaged (interlocked) with the engagement groove, the rotation about the third guide bar 31 of the third group lens barrel 30 is restricted. Further, a third group cam follower 33 is attached to the third group lens barrel 30. The third group cam follower 33 is rotatable about the axis line in a direction perpendicular to the optical axis A of the imaging optical system and engaged with a third group cam groove 83 of the cam cylinder 80 described later.

The aperture unit 36 is fixed to the third group lens barrel 30. The aperture unit 36 changes an aperture diameter by driving an aperture blade and adjusts the amount of light passing through the optical path of the imaging optical system (the amount of light entering the image pickup device L7). Note that a configuration of the aperture unit 36 is not particularly limited, and various known configurations can be applied.

The fourth group lens L4 is held in a fourth group lens barrel 40 and moves in the optical axis A direction together with the fourth group lens barrel 40. The fourth group lens barrel 40 is a member that holds the fourth group lens L4 and is guided (supported) so as to be movable in the optical axis A direction, and the rotation is restricted by a fourth guide bar 41 and the second guide bar 22.

Specifically, the fourth group lens barrel 40 is provided with a sleeve portion, and this sleeve portion is engaged with the fourth guide bar 41 extending in the optical axis A direction. In such a way, the fourth group lens barrel 40 is guided (supported) so as to be movable in the optical axis A direction by using the fourth guide bar 41. Further, the fourth group lens barrel 40 is provided with an engagement groove that is substantially U-shaped when viewed in the optical axis A direction, and this engagement groove is engaged (interlocked) with the second guide bar 22. Accordingly, the rotation about the fourth guide bar 41 of the fourth group lens barrel 40 is restricted. Further, the fourth group cam follower 43 is attached to the fourth group lens barrel 40 so as to be rotatable. The fourth group cam follower 43 is engaged (interlocked) with a fourth group cam groove 84 of the cam cylinder 80 described later.

The fifth group lens L5 is held in a fifth group lens barrel 50 and moves in the optical axis A direction together with the fifth group lens barrel 50. The fifth group lens barrel 50 is a member that holds the fifth group lens L5 and is guided (supported) so as to be movable in the optical axis A direction, and the rotation is restricted by a fifth guide bar 51 extending in the optical axis A direction and the sixth guide bar 52.

For example, the fifth group lens barrel 50 is provided with a sleeve portion and an engagement groove that is substantially U-shaped when viewed in the optical axis A direction. Further, the fifth guide bar 51 is inserted through the sleeve portion, and the fifth group lens barrel 50 is guided (supported) so as to be movable in the optical axis A direction by the fifth guide bar 51. Further, a sixth guide bar 52 is engaged (interlocked) with the engagement groove, and the rotation about the fifth guide bar 51 of the fifth group lens barrel 50 is restricted. The fifth group rack member 54 is attached to the fifth group lens barrel 50. The fifth group rack member 54 is a member that receives drive force of a fifth group stepping motor 115 that is a source of drive force of the fifth group lens barrel 50.

The fifth group stepping motor 115 is a source of the drive force to move the fifth group lens barrel 50 in the optical axis A direction. The fifth group stepping motor 115 is fixed to the fixed lens barrel 101 and engaged with the fifth group rack member 54. When the fifth group stepping motor 115 generates drive force in the optical axis A direction, the fifth group lens barrel 50 moves (forward and backward) in the optical axis A direction via the fifth group rack member 54, and the focusing operation can be performed.

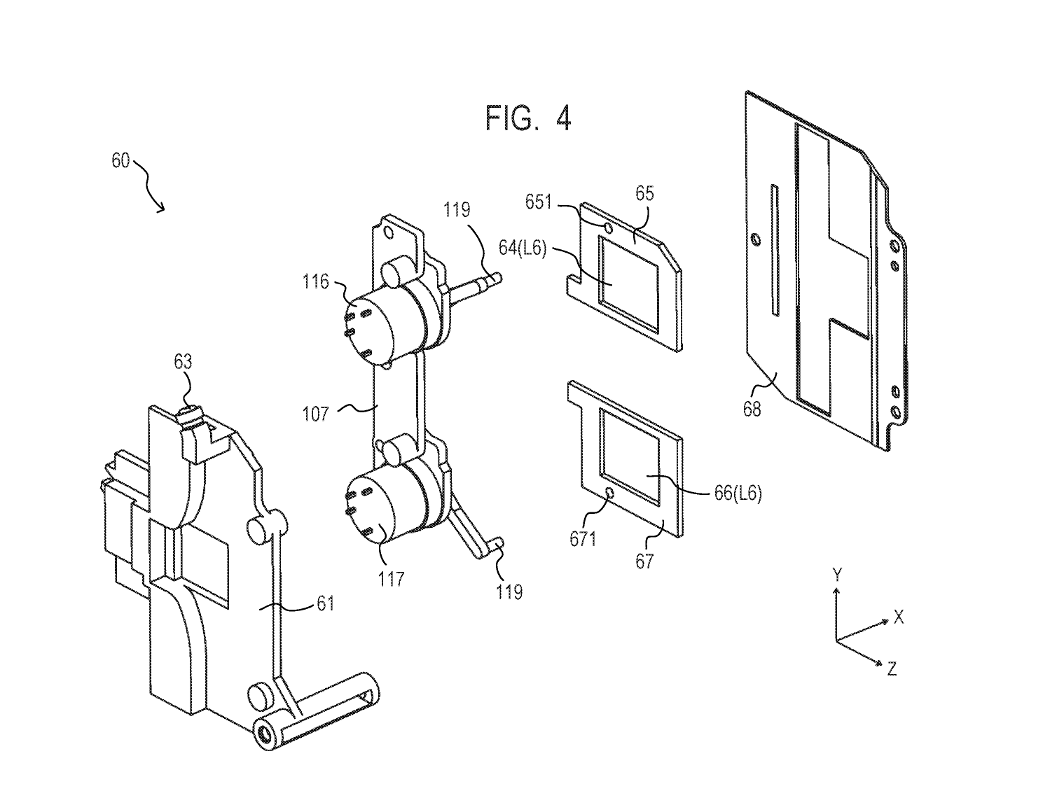

FIG. 4 is a perspective exploded view schematically illustrating a configuration example of the optical filter unit 60. The optical filter unit 60 has a removable optical filter L6 on the optical path of the imaging optical system and an optical filter driving mechanism that inserts and removes the optical filter L6 on the optical path. For example, an IR cut filter 64 and a band-pass filter 66 are applied to the optical filter L6.

The IR cut filter 64 is a filter having optical characteristics for cutting infrared rays. The band-pass filter 66 is a filter having optical characteristics for transmitting a light beam of a specific wavelength range. These optical filters L6 (64, 66) are held by optical filter holding frames 65 and 67, respectively. The optical filter holding frames 65 and 67 are members that hold the optical filter L6 so as to be movable. The optical filter holding frames 65 and 67 are held by an optical filter unit frame 61 and a cover member 68 and are movable in the direction perpendicular to the optical axis A of the imaging optical system (movable in a plane perpendicular to the optical axis A) such that the optical filter L6 can be inserted into and removed from the optical path.

The optical filter driving mechanism has optical filter insertion-removal motors 116 and 117. The optical filter insertion-removal motors 116 and 117 are drive sources to insert and remove the optical filters L6 (64, 66) together with the optical filter holding frames 65 and 67 and are fixed to an optical filter insertion-removal motor holding member 107. The optical filter insertion-removal motor holding member 107 is a member that supports the optical filter insertion-removal motors 116 and 117 and is fixed to the fixed lens barrel 101.

Engagement arms 119 each rotatable in a plane perpendicular to the optical axis A of the imaging optical system are provided to rotation output shafts of the optical filter insertion-removal motors 116 and 117, respectively. The engagement arms 119 are engaged with engaging holes 651 and 671 provided in the optical filter holding frames 65 and 67, respectively. When these engagement arms 119 are rotated by rotation power of the optical filter insertion-removal motors 116 and 117, the optical filters L6 (64, 66) are inserted into and removed from the optical path together with the optical filter holding frames 65 and 67, respectively.

When the IR cut filter 64 is inserted into the optical path, an infrared light is cut from the light entering the image pickup device L7, and thereby a light beam suitable for generating a typical color image is obtained. When the band-pass filter 66 is inserted into the optical path, only a light beam of a specific wavelength range such as a near-infrared light enters the image pickup device L7, for example, and thereby a light beam suitable for generating an image with higher contrast is obtained. When the IR cut filter 64 and the band-pass filter 66 are removed from the optical path, a light beam including an infrared ray enters the image pickup device L7, and thereby a greater amount of light can be obtained such that an image can be captured even under low luminance such as nighttime.

Further, the optical filter unit frame 61 is guided (supported) so as to be movable in the optical axis A direction of the imaging optical system and the rotation is restricted by the fifth guide bar 51 and the sixth guide bar 52. Specifically, the optical filter unit frame 61 is provided with a sleeve portion and an engagement groove that is substantially U-shaped when viewed in the optical axis A direction. Then, the sixth guide bar 52 is inserted through the sleeve portion, and thereby the optical filter unit frame 61 is guided (supported) so as to be movable in the optical axis A direction. Since the fifth guide bar 51 is engaged (interlocked) with the engagement groove, the rotation about the sixth guide bar 52 is restricted.

Further, an optical filter cam follower 63 is attached to the optical filter unit frame 61. The optical filter cam follower 63 is engaged (interlocked) with an optical filter cam groove 86 of the cam cylinder 80 described later. Note that the optical filter cam follower 63 is rotatable about the axis line in a direction perpendicular to the optical axis A.

Turning back to FIG. 1 to FIG. 3, the image pickup device L7 detects an incident light and generates an electric signal (imaging signal). The image pickup device L7 is fixed on a sensor substrate 76, and the sensor substrate 76 is held in the image pickup device holding frame 70. The image pickup device holding frame 70 is a member that holds the image pickup device L7 together with the sensor substrate 76 and is guided (supported) so as to be movable in the optical axis A direction and rotation is restricted by a seventh guide bar 71 and the eighth guide bar 72 extending in the optical axis A direction.

Specifically, the image pickup device holding frame 70 is provided with a sleeve portion and guided (supported) so as to be movable in the optical axis A direction by the seventh guide bar 71. Further, the image pickup device holding frame 70 is provided with an engagement groove that is substantially U-shaped when viewed in the optical axis A direction, and the eighth guide bar 72 is engaged (interlocked) with the engagement groove. Thereby, rotation about the seventh guide bar 71 of the image pickup device holding frame 70 is restricted. In addition, an image pickup device rack member 74 is attached to the image pickup device holding frame 70 so as to be rotatable in a plane perpendicular to the optical axis A direction.

In addition, an image pickup device position detection scale 75 that detects the position of the image pickup device L7 (the image pickup device holding frame 70) in the optical axis A direction is fixed to the image pickup device holding frame 70. Further, an image pickup device position sensor 114 that detects a position of the image pickup device holding frame 70 in the optical axis A direction is fixed to the rear lens barrel 102. It is possible to detect the position of the image pickup device L7 in the optical axis A direction by detecting the image pickup device position detection scale 75 by using the image pickup device position sensor 114. Note that the same configuration as that of the second group position detection scale 25 and the second group position sensor 113 used for detecting the position of the second group lens barrel 20a in the optical axis A direction can be applied to the configuration of the image pickup device position sensor 114 and the image pickup device position detection scale 75.

Each of the first guide bar 21, the second guide bar 22, the fifth guide bar 51, the sixth guide bar 52, the seventh guide bar 71, and the eighth guide bar 72 is held between the fixed lens barrel 101 and the rear lens barrel 102. Further, the imaging device 1 has a guide bar holding member 103 that holds the third guide bar 31 and the fourth guide bar 41. The guide bar holding member 103 is fixed to the fixed lens barrel 101, and the third guide bar 31 and the fourth guide bar 41 are held between the fixed lens barrel 101 and the guide bar holding member 103. Note that each of the first to eighth guide bars 21, 22, 31, 41, 51, 52, 71, and 72 is a bar-shaped member extending in the optical axis A direction of the imaging optical system.

The cam cylinder 80 is a member rotatable about a rotation axis B (rotation center line) parallel to the optical axis A. The cam cylinder 80 is held between the fixed lens barrel 101 and the rear lens barrel 102 via a cam cylinder actuation member 81 so as to be rotatable. Further, the cam cylinder 80 is actuated in one direction (for example, +X-direction) in the optical axis A direction by the cam cylinder actuation member 81.

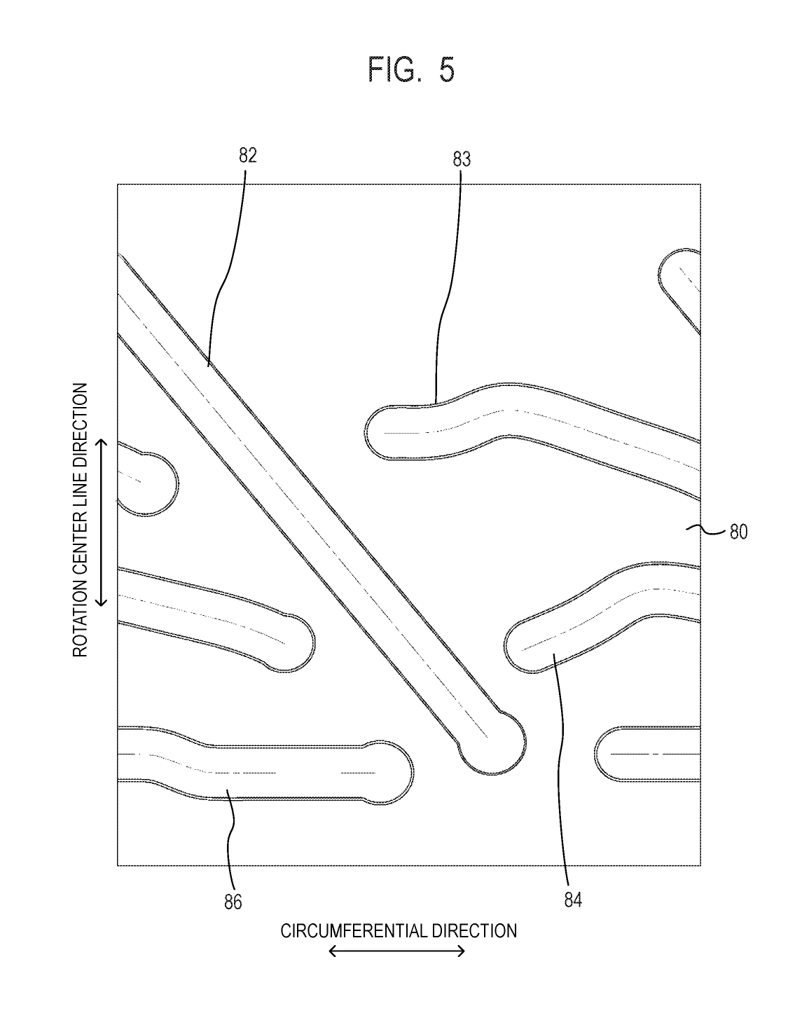

FIG. 5 is an expansion view illustrating an example configuration of a cam groove provided to the cam cylinder 80. As illustrated in FIG. 5, the cam cylinder 80 is provided with the second group cam groove 82, the third group cam groove 83, the fourth group cam groove 84, and the optical filter cam groove 86. The first cam follower 231 and the second cam follower 232 are engaged with the second group cam groove 82. The third group cam follower 33 is engaged with the third group cam groove 83. The fourth group cam follower 43 is engaged with the fourth group cam groove 84. The optical filter cam follower 63 is engaged with the optical filter cam groove 86.

The first actuator 111 is a source of drive force to move the second group lens barrel 20a, the third group lens barrel 30, the fourth group lens barrel 40, and the optical filter unit 60 in the optical axis A direction. A vibration-type linear actuator is applied to the first actuator 111, for example. Further, the first actuator 111 is fixed to the fixed lens barrel 101 and engaged with the second group rack member 24a. When the first actuator 111 generates drive force in the optical axis A direction, the second group lens barrel 20a moves (forward and backward) in the optical axis A direction via the second group rack member 24a. When the second group lens barrel 20a moves in the optical axis A direction, the cam cylinder 80 engaged with the first cam follower 231 and the second cam follower 232 rotates about the rotation axis B thereof (axis line parallel to the optical axis A).

When the cam cylinder 80 rotates, the third group lens barrel 30, the fourth group lens barrel 40, and the optical filter unit 60 move (forward and backward) in the optical axis A direction via the third group cam follower 33 engaged with the third group cam groove 83, the fourth group cam follower 43 engaged with the fourth group cam groove 84, and the optical filter cam follower 63 engaged with the optical filter cam groove 86. In such a way, the second group lens barrel 20a, the third group lens barrel 30, the fourth group lens barrel 40, and the optical filter unit 60 can be moved in the optical axis A direction of the imaging optical system by the drive force of the first actuator 111.

The second actuator 112 is a source of drive force to move the image pickup device holding frame 70 in the optical axis A direction. A vibration-type linear actuator can be applied to the second actuator 112 in the same manner as the first actuator 111, for example. The second actuator 112 is fixed to the rear lens barrel 102 and engaged with the image pickup device rack member 74. When the second actuator 112 generates drive force in the optical axis A direction, the image pickup device holding frame 70 moves forward and backward in the optical axis A direction via the image pickup device rack member 74. In such a way, the image pickup device L7 can be moved together with the image pickup device holding frame 70 in the optical axis A direction of the imaging optical system by the drive force of the second actuator 112.

By driving the first actuator 111 and the second actuator 112 in such a way, the second group lens barrel 20a, the third group lens barrel 30, the fourth group lens barrel 40, the optical filter unit 60, and the image pickup device holding frame 70 can be moved (forward and backward) in the optical axis A direction. Thereby, zooming and focusing can be performed.

Note that the configurations of the first actuator 111 and the second actuator 112 are not particularly limited. For the first actuator 111 and the second actuator 112, a vibration-type linear actuator can be applied as described above. For example, the vibration-type linear actuator is formed of a slider and a vibrator (not illustrated), when a frequency signal is input to the vibrator via a flexible printed board (not illustrated), approximately elliptical motion occurs in the vibrator, and this allows drive force to occur on a pressure contact surface against the slider.

A lens substrate 105 is a circuit board fixed to the fixed lens barrel 101. The lens substrate 105 inputs and outputs an electric signal in and from the image pickup device L7 via an electric wiring 104. Further, the lens substrate 105 transmits and receives an electric signal to and from each actuator such as the first actuator 111, the second actuator 112, the fifth group stepping motor 115, the optical filter insertion-removal motors 116 and 117, or the like or each sensor such as the second group position sensor 113, the image pickup device position sensor 114, or the like via a flexible printed board (not illustrated).

One end of the electric wiring 104 is connected to the sensor substrate 76, and the other end is connected to the lens substrate 105. The electric wiring 104 is preferably configured to be easily deformed such that, when the image pickup device holding frame 70 moves in the optical axis A direction, no excessive load is applied to the second actuator 112 (vibration-type linear actuator). In the present embodiment, the electric wiring 104 has a shape that is curved in a U shape and has a curvature such that no excessive load is applied to the second actuator 112. However, the specific configuration of the electric wiring 104 is not particularly limited.

A heat conduction member 106 is a member that conducts heat generated in the sensor substrate 76 to a heatsink (not illustrated) and arranged to suppress a rise in the temperature of the image pickup device L7 or the like. A flexible sheet member having a high thermal conductivity such as a graphite sheet is applied to the heat conduction member 106, for example. Further, one end of the heat conduction member 106 is fixed (connected) to the sensor substrate 76, and the other end is fixed (connected) to the heatsink (not illustrated). Note that the heat conduction member 106 is configured to be easily deformed in the direction of the axis line so as not to increase the load applied to the second actuator 112 (thrust required for moving) when the second actuator 112 moves the image pickup device holding frame 70 in the optical axis A direction. For example, as illustrated in FIG. 1 or FIG. 3, a bellows structure can be applied so as to facilitate expansion and contraction in the optical axis A direction.

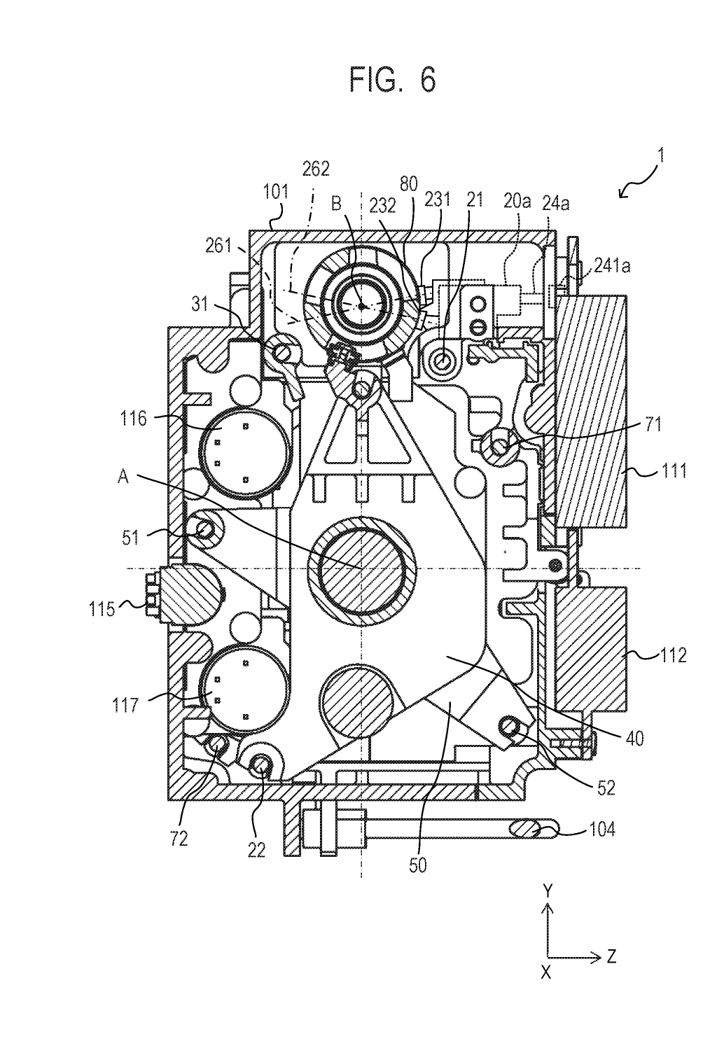

The arrangement of each member will now be described with reference to FIG. 6. FIG. 6 is a sectional view illustrating the imaging device 1 taken along a plane perpendicular to the optical axis A of the imaging optical system when viewed from the front. The cam cylinder 80 is arranged at a position (separate position) that is shifted on the +Y-direction side to the optical axis A of the imaging optical system. The first actuator 111 and the second actuator 112 are arranged at a position (separate position) that is shifted on the +Z-direction side to the optical axis A of the imaging optical system.

For example, the first actuator 111 is arranged on a side face of the +Z-direction side of the fixed lens barrel 101, and the second actuator 112 is arranged on a side face of the +Z-direction side of the rear lens barrel 102. The fifth group stepping motor 115 is arranged at a position (separate position) that is shifted on the −Z-direction side to the optical axis A of the imaging optical system. The electric wiring 104 is arranged at a position (separate position) that is shifted on the −Y-direction side to the optical axis A of the imaging optical system and can bend in a plane approximately parallel to the X-Z plane. Further, the second group rack member 24a is arranged at a position (separate position) that is shifted on the +Z-direction side to the optical axis A of the imaging optical system and the rotation axis B of the cam cylinder 80. That is, the second group rack member 24a is arranged between the cam cylinder 80 and the first actuator 111 in the Z-direction.

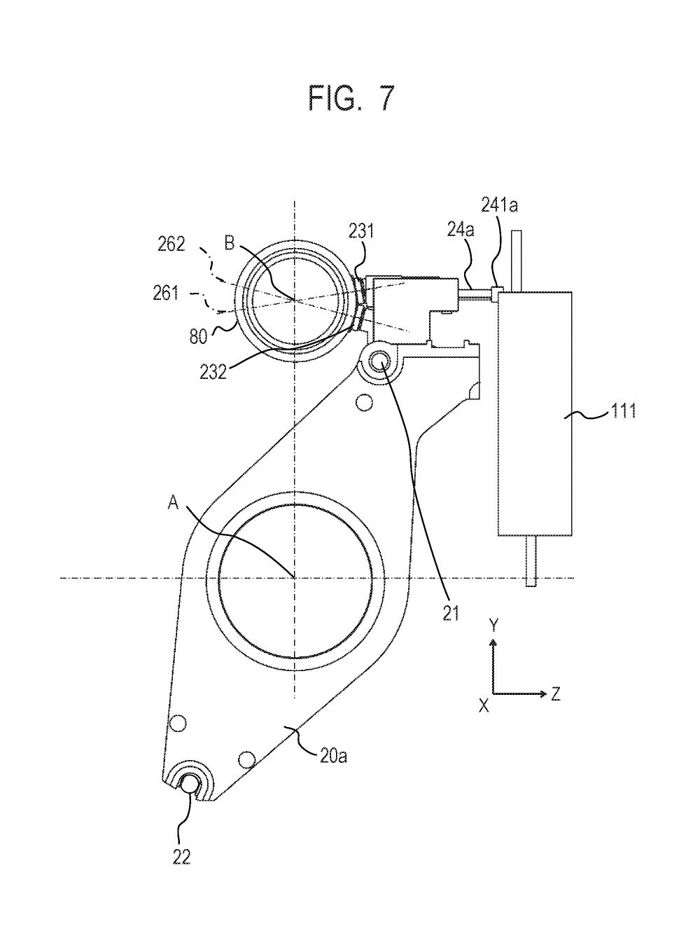

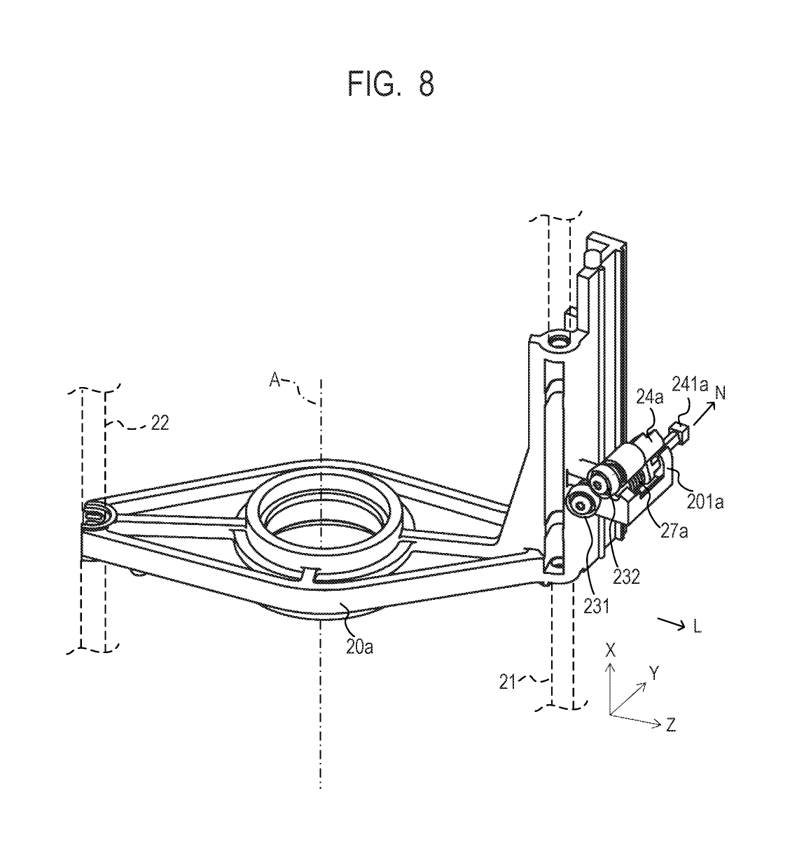

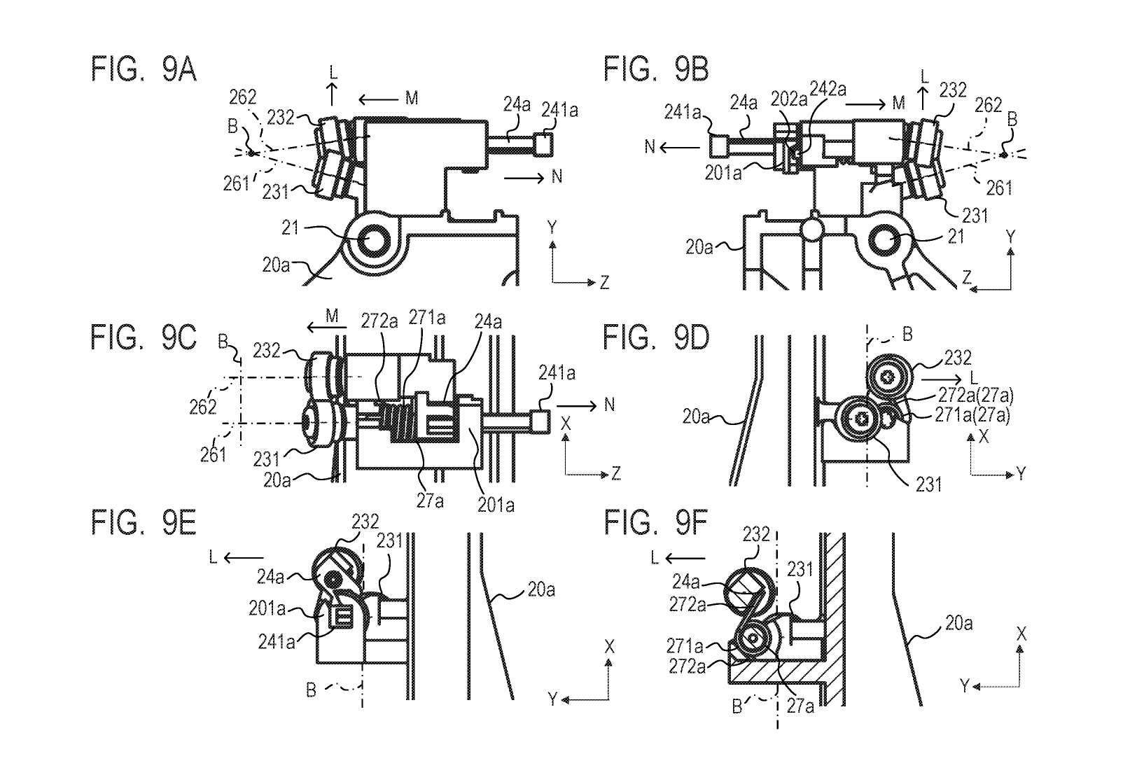

Next, a configuration example of the second group lens barrel 20a and the second group rack member 24a will be described. FIG. 7 is a diagram when viewed in the optical axis A direction and schematically illustrating a configuration example of the second group lens barrel 20a and the second group rack member 24a. FIG. 8 is a perspective view schematically illustrating a configuration example of the second group lens barrel 20a and the second group rack member 24a. FIG. 9A to FIG. 9F are diagrams schematically illustrating a configuration example of a part of the second group lens barrel 20a, the second group rack member 24a, and the periphery thereof. Specifically, FIG. 9A is a diagram when viewed from the −X-side, FIG. 9B is a diagram when viewed from the +X-side, FIG. 9C is a diagram when viewed from the +Y-side, FIG. 9D is a diagram when viewed from the −Z-side, FIG. 9E is a diagram when viewed from the +Z-side, and FIG. 9F is a sectional view when viewed from the +Z-side. Further, each of arrows L and arrows N in FIG. 7 to FIG. 9F indicates the direction of actuation force of the second group rack member 24a applied by a rack spring 27a.

As illustrated in FIG. 7, a rotation center line 261 of the first cam follower 231 and a rotation center line 262 of the second cam follower 232 are perpendicular to the optical axis A (X-direction) (parallel to the Y-Z plane) and pass through the rotation axis B (rotation center line) of the cam cylinder 80. The second group rack member 24a is arranged between the cam cylinder 80 and the first actuator 111 in the Z-direction. Therefore, the first actuator 111 is at a position opposite to the cam cylinder 80 (+Z-direction side) when viewed from the second group rack member 24a. Further, the second group rack member 24a is relatively movable with respect to the second group lens barrel 20a in the direction of approaching the first actuator 111, in the direction of approaching the cam cylinder 80 (±Z-direction), and in the direction perpendicular to the optical axis A (±Y-direction).

An actuator connecting portion 241a is integrally provided on the side close to the first actuator 111 (+Z-direction side) to the second group rack member 24a. That is, the actuator connecting portion 241a forms a part of the second group rack member 24a. Further, the second group rack member 24a is engaged with the first actuator 111 via the actuator connecting portion 241a. Therefore, when the first actuator 111 moves in the optical axis A direction of the imaging optical system, the drive force is transmitted to the second group lens barrel 20a via the second group rack member 24a (the actuator connecting portion 241a). Thereby, the second group lens barrel 20a is driven in the optical axis A direction (moves in the optical axis A direction).

The second cam follower 232 is rotatably attached to the second group rack member 24a on the side close to the cam cylinder 80. Note that the first cam follower 231 is rotatable with respect to the second group rack member 24a and relatively movable together with the second group rack member 24a to the second group lens barrel 20a in the Y-direction and the Z-direction. The second cam follower 232 is then engaged with the second group cam groove 82 of the cam cylinder 80.

The second group rack member 24a is coupled to the second group lens barrel 20a. The second group rack member 24a is relatively movable with respect to the second group lens barrel 20a in the Z-direction (direction of approaching or separating from the cam cylinder 80 and the first actuator 111) and in the Y-direction (direction of approaching or separating from the first cam follower 231). Note that the second group rack member 24a may be relatively movable with respect to the second group lens barrel 20a in the Z-direction (direction of approaching or separating from the cam cylinder 80 and the first actuator 111) and may be rotatable about the axis line parallel to the Z-direction relative to the second group lens barrel 20a. Then, the second group rack member 24a is actuated in the direction (+Z-direction) of approaching the first actuator 111 and in the direction (+Y-direction) of separating from the first cam follower 231 by using the rack spring 27a, which is an example of an actuation member.

As illustrated in FIG. 7 and FIG. 8, the second group rack member 24a is actuated in the direction of the arrow N by the actuation force of the rack spring 27a, and thereby the actuator connecting portion 241a of the second group rack member 24a is actuated and engaged with the first actuator 111. Further, by the actuation force of the rack spring 27a in the direction of the arrow L, the second cam follower 232 together with the second group rack member 24a is actuated in the direction of separating from the first cam follower 231 in the +Y-direction (direction of the arrow L, the tangential direction of the circle of the cam cylinder 80). That is, the first cam follower 231 and the second cam follower 232 are actuated in the direction of separating from each other in the Y-direction by the actuation force of the rack spring 27a (actuation force in the direction of the arrow L).

The rack spring 27a, which is an example of an actuation member, has a coil spring portion 271a, which is an elastically compressively deformable compression coil spring portion, which is an example of a first actuation portion, and an arm portion 272a, which is an example of a second actuation portion. For example, a torsion spring can be applied to the rack spring 27a. The torsion spring applied to the rack spring 27a has a coil spring portion that is elastically compressively deformable in the direction of the axis line (the coil spring portion 271a) and two arm portions 272a protruded from both end portions of the coil spring portion 271a in the direction perpendicular to the axial line direction. Further, the coil spring portion 271a functions as a first actuation portion, and the two arm portions 272a protruded from the coil spring portion 271a function as a second actuation portion. Note that, to be precise, the rack spring 27a functions as the second actuation unit by being twisted so that the relative angle of the two arm portions 272a changes.

Further, as illustrated in FIG. 9B and FIG. 9C, the coil spring portion 271a actuates the second group rack member 24a in the diameter direction of the cam cylinder 80 (direction of the arrow N) within a plane perpendicular to the optical axis A of the imaging optical system (within a plane parallel to the Y-Z plane). Thereby, the second group rack member 24a and the second group lens barrel 20a are actuated in the direction of separating from each other (+Z-direction and −Z-direction, respectively). As a result, the second group rack member 24a is actuated to the first actuator 111. Further, due to actuation force of the coil spring portion 271a (compression spring portion) of the rack spring 27a in the direction of the axis line, force (moment) in the rotational direction about the first guide bar 21 is applied to the second group lens barrel 20a. Thereby, the second group lens barrel 20a is actuated in the direction perpendicular to the optical axis A of the imaging optical system (that is, direction perpendicular to the extending direction of the second guide bar 22) to the second guide bar 22. With such a configuration, the second group lens barrel 20a is held without backlash to the first guide bar 21 and the second guide bar 22.

Note that, as illustrated in FIG. 8 and FIG. 9A to FIG. 9F, when viewed in the optical axis A direction (in the Y-Z plane), the position where the second group lens barrel 20a is guided by the first guide bar 21 and the position where the second group lens barrel 20a is engaged with the second guide bar 22 are out of the extension line of actuation force applied by the coil spring portion 271a (first actuation portion) of the rack spring 27a. With such a configuration, the second group lens barrel 20a is actuated to both the first guide bar 21 and the second guide bar 22, and backlash to the first guide bar 21 and the second guide bar 22 is reduced.

The two arm portions 272a of the rack spring 27a actuate the second group lens barrel 20a and the second group rack member 24a in the direction of rotation about the center axis of the coil spring portion 271a.

As illustrated in FIG. 9C and FIG. 9F, for example, one arm portion 272a is latched to the second group lens barrel 20a, and the other arm portion 272a is latched to the second group rack member 24a. Therefore, a rotational moment about the axis line of the coil spring portion 271a (the center line parallel to the Z-direction) is applied to the second group lens barrel 20a and the second group rack member 24a. This rotational moment then actuates the first cam follower 231 and the second cam follower 232 in the direction of separating from each other (+Y- and −Y-directions, the opposite direction). In such a way, the arm portions 272a of rack spring 27a actuate the first cam follower 231 and the second cam follower 232 in the direction of separating from each other. Thereby, the first cam follower 231 and the second cam follower 232 are actuated to the inner peripheral surface (wall surface) of the second group cam groove 82, respectively. According to such a configuration, a state where there is no backlash between the first cam follower 231 and the cam cylinder 80 and between the second cam follower 232 and the cam cylinder 80 is maintained.

That is, the first cam follower 231 and the second cam follower 232 are engaged with the same single second group cam groove 82. The first cam follower 231 and the second cam follower 232 are then actuated by the rack spring 27a in the direction of separating from each other in the direction perpendicular to the rotational axis B (rotation center line) of the cam cylinder 80 (the circumferential direction of the cam cylinder 80). Thereby, the first cam follower 231 and the second cam follower 232 will push (being actuated to come into contact with) the two inner peripheral surfaces (two wall surfaces) of the second group cam groove 82 in the opposite direction, respectively (+Y- and −Y-directions, that is, at least a direction different from the extending direction of the second group cam groove 82). Therefore, backlash between the first cam follower 231 and second cam follower 232 and the cam cylinder 80 (the inner peripheral surface of the second group cam groove 82) can be reduced.

As described above, the backlash of the two cam followers to the cam cylinder 80 (the first cam follower 231 and the second cam follower 232) and the backlash of the second group lens barrel 20a to the first actuator 111 can be reduced by the single rack spring 27a, which is an example of an actuation member. According to such a configuration, the number of components can be reduced compared to a configuration in which the backlash of the two cam followers to the cam cylinder 80 (the first cam follower 231 and the second cam follower 232) and the backlash of the second group lens barrel 20a to the first actuator 111 are reduced by using separate actuation members, respectively. Therefore, the number of assembling steps can be reduced.

Further, since the friction loss can be reduced by the actuation with a single component, a load applied to the first actuator 111 can be reduced. Further, since the second group lens barrel 20a is actuated to the second guide bar 22, an image shaking due to shaft misalignment in a zooming operation (when the second group lens L2, the third group lens L3, and the fourth group lens L4 move) can also be reduced.

Note that the second group rack member 24a and second group lens barrel 20a may have detachment prevention portions 201a and 242a, respectively, which prevent the second group rack member 24a from being detached from the second group lens barrel 20a due to actuation force of the rack spring 27a after being assembled.

For example, the detachment prevention portion 201a of the second group lens barrel 20a has a configuration that can be latched on the +Z-direction side (the side close to the first actuator 111) of the detachment prevention portion 242a of the second group rack member 24a. Specifically, as illustrated in FIG. 9B, FIG. 9C, and FIG. 9E, for example, the detachment prevention portion 201a of the second group lens barrel 20a is located on the +Z-direction side (the side close to the first actuator 111) of the detachment prevention portion 242a of the second group rack member 24a and is provided with a groove or the like extending in the Z-direction. Further, a part of the second group rack member 24a enters the groove of the detachment prevention portion 201a. The second group rack member 24a is able to move in the +Z-direction (direction of approaching to the first actuator 111) up to a position where the detachment prevention portion 242a latches to (comes into contact with) the detachment prevention portion 201a of the second group lens barrel 20a. Then, the detachment prevention portion 242a of the second group rack member 24a is actuated toward the detachment prevention portion 201a of the second group lens barrel 20a by actuation force of the coil spring portion 271a of the rack spring 27a. Therefore, with the detachment prevention portion 242a of the second group rack member 24a being latched to the detachment prevention portion 201a of the second group lens barrel 20a, detachment of the second group rack member 24a from the second group lens barrel 20a is prevented.

Note that the detachment prevention portion 242a of the second group rack member 24a may be of any configuration that can be latched to the detachment prevention portion 201a of the second group lens barrel 20a, and the specific configuration thereof is not particularly limited. According to such a configuration, the second group rack member 24a is not detached due to actuation force of the rack spring 27a even after the second group rack member 24a, the rack spring 27a, and the second group lens barrel 20a are assembled. Accordingly, since the first actuator 111 is attached with the second group rack member 24a and the rack spring 27a being assembled with (being engaged with) the second group lens barrel 20a, assembly performance is improved.

Further, the first cam follower 231 and the second cam follower 232 are actuated by the arm portion 272a of the rack spring 27a so as to separate from each other in the Y-direction (in the circumferential direction of the cam cylinder 80). Thereby, the second cam follower 232 is actuated to a position away from the second group cam groove 82 by actuation force of the arm portion 272a of the rack spring 27a. An insertion guide portion 202a may be provided to the detachment prevention portion 201a of the second group lens barrel 20a such that the second cam follower 232 is held in a position for facilitating engagement with the second group cam groove 82, when the first actuator 111 is attached after the second group rack member 24a and the rack spring 27a are attached to the second group lens barrel 20a.

The insertion guide portion 202a has an inclined surface inclined to the direction of actuation force of the arm portion 272a of the rack spring 27a. Further, in response to being actuated toward the insertion guide portion 202a by actuation force of the arm portion 272a of the rack spring 27a, a part of the second group rack member 24a (for example, the detachment prevention portion 242a ) is actuated toward the cam cylinder 80 side by the inclined surface of the insertion guide portion 202a. With such a configuration, the position of the second cam follower 232 (the moving range in the Y-direction) in the circumferential direction (tangential direction of the circle) of the cam cylinder 80 is restricted by the insertion guide portion to a position for facilitating engagement with the second group cam groove 82. That is, the insertion guide portion 202a restricts the position of the second cam follower 232 in the circumferential direction of the cam cylinder 80 (the position to the second group cam groove 82) so as to facilitate engagement with the second group cam groove 82 (in other words, so as not to be excessively separated from the first cam follower 231 in the Y-direction).

Note that the position in the Y-direction of the inclined surface of the insertion guide portion 202a may be any position that facilitate the second cam follower 232 to be engaged with the second group cam groove 82 (the position close to the second group cam groove 82) of the cam cylinder 80 and is not particularly limited. According to such a configuration, assembly performance can be improved when the first actuator 111 is engaged with the second group rack member 24a.

Furthermore, the position of the first guide bar 21 in a plane perpendicular to the optical axis A of the imaging optical system may not be a position on the extended line of the actuating direction of the rack spring 27a. According to such a configuration, sliding resistance at the second group lens barrel 20a and the first guide bar 21 can be reduced, and thereby a load in driving on the first actuator 111 can be reduced. As described above, it is possible to increase assembly performance of the imaging device 1 while reducing the load applied to the first actuator 111.

Note that, in the present embodiment, although the configuration in which the first cam follower 231 and the second cam follower 232 are engaged with the same cam groove (the second group cam groove 82) has been illustrated as an example, the embodiment is not limited to such a configuration. For example, the first cam follower 231 and the second cam follower 232 may be configured to be engaged with different cam grooves, respectively, and actuated to the inner circumferential surface of each cam groove. Further, although the configuration in which the first cam follower 231 and the second cam follower 232 are actuated in the direction of separating from each other in the Y-direction has been illustrated as an example, the first cam follower 231 and the second cam follower 232 may be configured to be actuated in the direction of approaching each other.

### Second Embodiment

Next, an imaging device 1 according to a second embodiment of the present invention will be described. In the imaging device 1 according to the second embodiment, configurations of a second group lens barrel 20a, a second group rack member 24b, and a rack spring 27b are different from those of the first embodiment, and the same configuration can be applied to others. Therefore, a part to which a configuration common to the first embodiment can be applied is labeled with the same reference numeral as in the first embodiment, and the description thereof may be omitted.

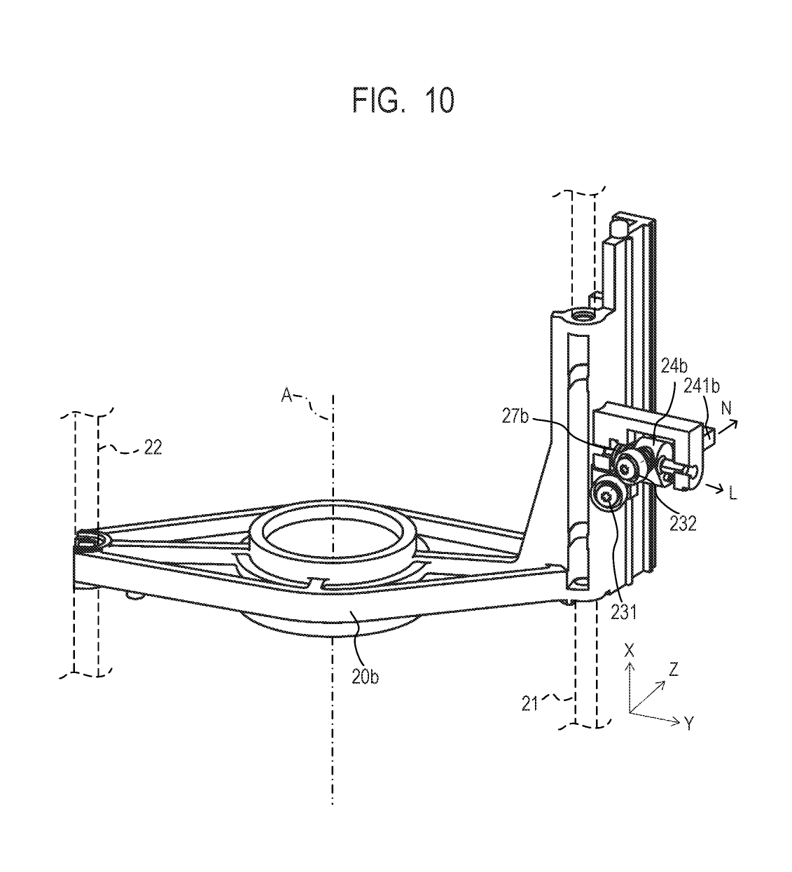

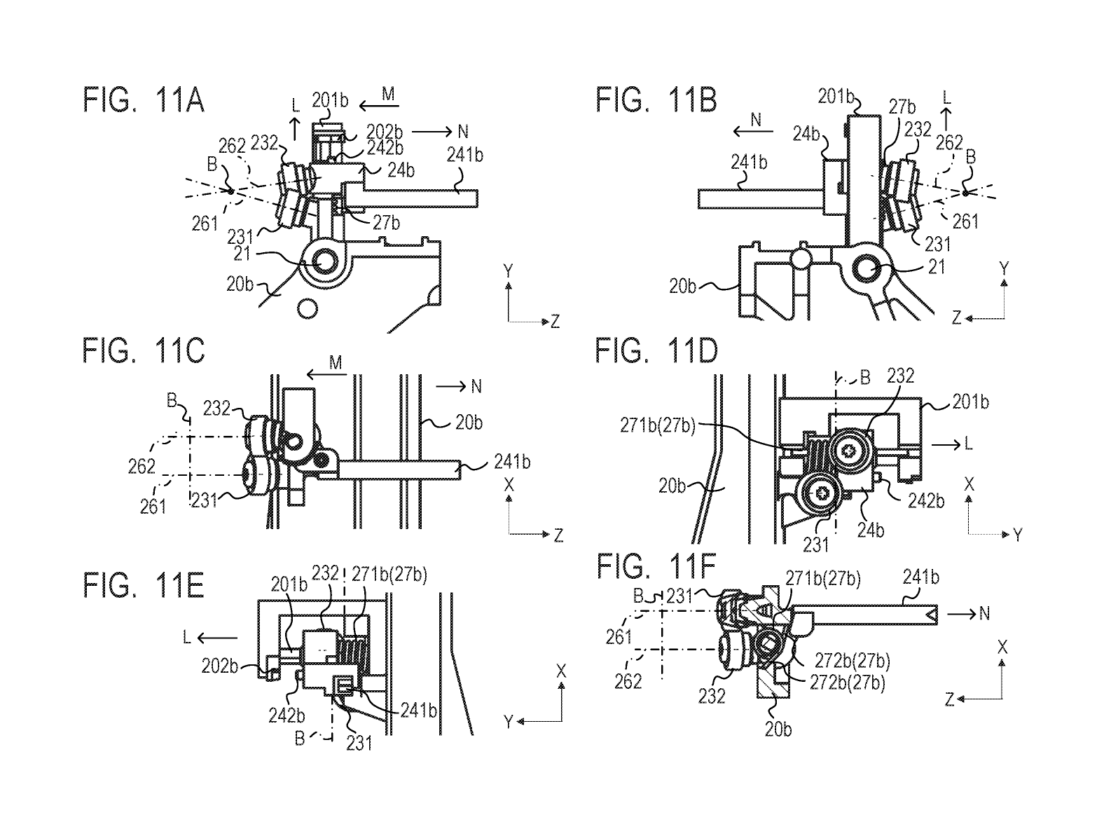

FIG. 10 is a perspective view schematically illustrating a configuration example of a second group lens barrel 20b and a second group rack member 24b of the imaging device 1 according to the second embodiment of the present invention. FIG. 11A to FIG. 11F are diagrams schematically illustrating a configuration example of a part of the second group lens barrel 20b (optical member-holding member) and a second group rack member 24b of the imaging device 1 according to the second embodiment. Note that FIG. 11A is a diagram when viewed from the −X-side, FIG. 11B is a diagram when viewed from the +X-side, FIG. 11C is a diagram when viewed from the +Y-side, FIG. 11D is a diagram when viewed from the −Z-side, FIG. 11E is a diagram when viewed from the +Z-side, and FIG. 11F is a sectional view when viewed from the +Y-side.

The second group rack member 24b is actuated by the rack spring 27b, which is an example of an actuation member, in the direction perpendicular to the direction parallel to the optical axis A of the imaging optical system. The rack spring 27b has an elastically compressively deformable compression coil spring portion 271b (compression spring portion), which is an example of a second actuation portion, and has two arm portions 272b, which are an example of a first actuation portion. A torsion spring can be applied to the rack spring 27b in the second embodiment. However, the direction of the axis line of the coil spring portion 271b of the rack spring 27b and the configuration (the protruding direction) of the arm portion 272b provided so as to protrude from both end portions of the coil spring portion 271b are different compared to the first embodiment.

The axis line of the coil spring portion 271b (compression spring portion) is in parallel to the Y-direction. Further, the coil spring portion 271b of the rack spring 27b is arranged between the second group rack member 24b and the second group lens barrel 20b and actuates the second group rack member 24b (the second cam follower 232) and the second group lens barrel 20b (the first cam follower 231) in the direction of separating from each other in the Y-direction (circumferential direction of the cam cylinder 80). Therefore, backlash between the first cam follower 231 and the cam cylinder 80 and between the second cam follower 232 and the cam cylinder 80 can be reduced.

That is, the first cam follower 231 and the second cam follower 232 are engaged with the same single second group cam groove 82. Further, the first cam follower 231 and the second cam follower 232 are actuated by the rack spring 27b in the direction of separating from each other in the tangential direction of the circle of the cam cylinder 80 (±Y-direction). Thereby, the first cam follower 231 and the second cam follower 232 will push (being actuated to come into contact with) the two inner peripheral surfaces (two wall surfaces) of the second group cam groove 82 in the opposite direction, respectively (+Y and −Y-directions, that is, at least a direction different from the extending direction of the second group cam groove 82). Therefore, backlash between the first cam follower 231 and the cam cylinder 80 and between the second cam follower 232 and the cam cylinder 80 is reduced.

The rack spring 27b provides an actuation in the direction of rotation about the center axis of the coil spring portion 271b (compression spring portion) by using the two arm portions 272b. Specifically, as illustrated in FIG. 11E and FIG. 11F, the two arm portions 272b of the rack spring 27b extend within the X-Z-plane. One arm portion 272b of the rack spring 27b is engaged with (comes into contact with) the second group rack member 24b, and the other arm portion 272b is engaged with (comes into contact with) the second group lens barrel 20b.

The second group rack member 24b (the actuator connecting portion 241b ) and the second group lens barrel 20b are then actuated in the direction of separating from each other in ±Z-direction by actuation force (moment) of the two arm portions 272b within the X-Z-plane. Thereby, the actuator connecting portion 241b is engaged with the first actuator 111 with the second group rack member 24b being actuated toward the first actuator 111. Further, the second group lens barrel 20b is actuated to the second guide bar 22 by the moment (force in the rotational direction) about the first guide bar 21. Therefore, backlash between the second group lens barrel 20b and the second guide bar 22 can be reduced.

Note that, as illustrated in FIG. 10 and FIG. 11A to FIG. 11F, when viewed in the optical axis A direction (in the Y-Z-plane), the position where the second group lens barrel 20b is guided by the first guide bar 21 is out of the extension line of actuation force applied by the arm portion 272b (first actuation portion) of the rack spring 27b. Similarly, the position where the second group lens barrel 20b is engaged with the second guide bar 22 is out of the extension line of actuation force applied by the arm portion 272b (first actuation portion) of the rack spring 27b. With such a configuration, the second group lens barrel 20b is actuated to both the first guide bar 21 and the second guide bar 22, and backlash to the first guide bar 21 and the second guide bar 22 can be reduced.

As described above, the backlash of the two cam followers to the cam cylinder 80 (the first cam follower 231 and the second cam follower 232) and the backlash of the second group lens barrel 20b to the first actuator 111 can be reduced by the single rack spring 27b. Therefore, according to such a configuration, the same advantage as in the first embodiment can be achieved.

Also in the second embodiment, as with the first embodiment, the second group lens barrel 20b and the second group rack member 24b may have detachment prevention portions 201b and 242b, respectively. For example, the detachment prevention portion 201b of the second group lens barrel 20b is configured to be able to latch on the +Y-direction side (direction of actuation force of the coil spring portion 271b of the rack spring 27b) of the detachment prevention portion 242b of the second group rack member 24b.

Specifically, as illustrated in FIG. 11C, FIG. 11D, and FIG. 11E, the detachment prevention portion 201b of the second group lens barrel 20b is located on the +Y-direction side of the detachment prevention portion 242b of the second group rack member 24b and is provided with a groove or the like extending in the Y-direction. Further, a part of the second group rack member 24b enters the groove of the detachment prevention portion 201b. The second group rack member 24b is able to move in the +Y-direction up to a position where the detachment prevention portion 242b latches to (comes into contact with) the detachment prevention portion 201b of the second group lens barrel 20b. Then, the detachment prevention portion 242b of the second group rack member 24b is actuated toward the detachment prevention portion 201b of the second group lens barrel 20b by actuation force of the coil spring portion 271b of the rack spring 27b. Thereby, detachment of the second group rack member 24b from the second group lens barrel 20b is prevented.

Note that the detachment prevention portion 242b of the second group rack member 24b may be of any configuration that can be latched to the detachment prevention portion 201b of the second group lens barrel 20b, and the specific configuration thereof is not particularly limited. According to such a configuration, the second group rack member 24b is not detached due to actuation force of the rack spring 27b even after the second group rack member 24b, the rack spring 27b, and the second group lens barrel 20b are assembled. Therefore, a state where the second group rack member 24b and the rack spring 27b are assembled with the second group lens barrel 20b is maintained (the engaged state is maintained) when the first actuator 111 is attached. Accordingly, assembly performance of the imaging device 1 is improved.

Furthermore, also in the second embodiment, an insertion guide portion 202b may be provided to the detachment prevention portion 201b of the second group lens barrel 20b. The insertion guide portion 202b has an inclined surface inclined to the direction of actuation force of the coil spring portion 271b of the rack spring 27b. Further, in response to being actuated toward the insertion guide portion 202b by actuation force of the coil spring portion 271b of the rack spring 27b, a part of the second group rack member 24b (for example, the detachment prevention portion 242b ) is actuated toward the cam cylinder 80 side by the inclined surface of the insertion guide portion 202b. Therefore, as with the first embodiment, the position of the second cam follower 232 in the circumferential direction of the cam cylinder 80 (the position to the second group cam groove 82) is restricted.

Note that the position in the Y-direction of the inclined surface of the insertion guide portion 202b may be any position that facilitates the second cam follower 232 to be engaged with the second group cam groove 82 (the position close to the second group cam groove 82) of the cam cylinder 80 and is not particularly limited. According to such a configuration, assembly performance can be improved when the first actuator 111 is engaged with the second group rack member 24b.

Furthermore, the position of the first guide bar 21 within a plane perpendicular to the optical axis A of the imaging optical system may be a position which is not on the extended line of the actuating direction of the rack spring 27b. According to such a configuration, sliding resistance at the second group lens barrel 20b and the first guide bar 21 can be reduced, and thereby a load in driving on the first actuator 111 can be reduced. As described above, it is possible to increase assembly performance of the imaging device 1 while reducing the load applied to the first actuator 111.

Surveillance Camera

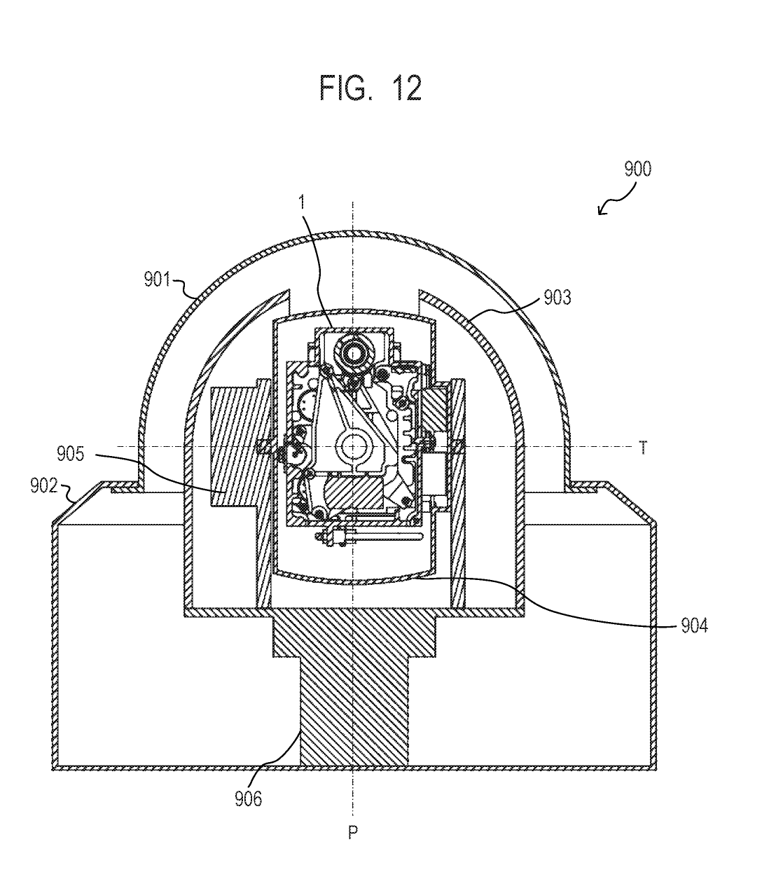

Next, a surveillance camera 900 according to an embodiment of the present invention will be described with reference to the FIG. 12. FIG. 12 is a sectional view schematically illustrating a configuration example of the surveillance camera 900 according to the embodiment of the present invention. The imaging device 1 according to the embodiment of the present invention is applied to the surveillance camera 900 according to the embodiment of the present invention. As illustrated in FIG. 12, the surveillance camera 900 has the imaging device 1, a camera case 904, an inner cover 903, a tilt unit 905, a pan unit 906, a dome 901, and a case 902.

The camera case 904 is a member that accommodates the imaging device 1. The tilt unit 905 supports the camera case 904 accommodating the imaging device 1 so as to be rotatable about a tilt axis T. Note that the tilt unit 905 has a tilt drive portion (not illustrated) formed of a stepping motor or the like, and the camera case 904 is driven in a tilt direction by the tilt drive portion. The pan unit 906 supports the tilt unit 905 so as to be rotatable about a pan axis P. The pan unit 906 has a pan drive portion (not illustrated) formed of a stepping motor or the like and the tilt unit 905 is electrically driven in a pan direction.

Thereby, the imaging device 1 is driven in the tilt direction and the pan direction. Further, the imaging device 1, the camera case 904, the inner cover 903, the tilt unit 905, and the pan unit 906 are accommodated in (covered with) the case 902 and a dome 901. The dome 901 is a transparent or translucent plastic cover member. Note that the configuration described above is a configuration example of the surveillance camera, and the surveillance camera of the present invention is not limited to such a configuration. In short, the surveillance camera of the present invention may be of any configuration that has the imaging device of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is a preferable technology for imaging devices. Further, according to the present invention, it is possible to reduce the number of components and reduce the load applied to the actuator.

This application claims the benefit of Japanese Patent Application No. 2017-242919, filed Dec. 19, 2017, which is hereby incorporated by reference herein in its entirety.

What is claimed is:

1. An imaging device having an imaging optical system having an optical member, the imaging device comprising:
an optical member-holding member that holds the optical member and is movable in an optical axis direction of the imaging optical system;
a coupling portion coupled to the optical member-holding member so as to be relatively movable with respect to the optical member-holding member;
a drive portion that moves the optical member-holding member in the optical axis direction via the coupling portion;
a cam cylinder that is rotatable about an axis line parallel to the optical axis;
a first cam follower provided to the optical member-holding member and engaged with a cam groove provided to the cam cylinder;
a second cam follower attached to the coupling portion and engaged with the cam groove provided to the cam cylinder; and
an actuation member that actuates the second cam follower to an inner peripheral surface of the cam groove of the cam cylinder and actuates the coupling portion toward the drive portion.

2. The imaging device according to claim 1,
wherein the actuation member has
a first actuation portion that actuates the second cam follower to the inner peripheral surface of the cam groove of the cam cylinder by actuating the first cam follower and the second cam follower in a direction of separating from each other, and
a second actuation portion that actuates the coupling portion toward the drive portion.

3. The imaging device according to claim 2, wherein the actuation member is a torsion spring that has a compressively deformable coil spring portion and an arm portion protruded from the coil spring portion.

4. The imaging device according to claim 3,
wherein the coil spring portion is the first actuation portion, and the coil spring portion actuates the drive portion and the coupling portion in an axis line direction of the coil spring portion, and
wherein the arm portion protruded from the coil spring portion is the second actuation portion, and the arm portion actuates the first cam follower and the second cam follower in a circumferential direction of the cam cylinder by actuating the first cam follower and the second cam follower in a circumferential direction about an axis line of the coil spring portion.

5. The imaging device according to claim 3,
wherein the arm portion protruded from the coil spring portion is the first actuation portion, and the arm portion actuates the drive portion and the coupling portion in a circumferential direction about an axis line of the coil spring portion, and
wherein the coil spring portion is the second actuation portion, and the coil spring portion actuates the first cam follower and the second cam follower in a tangential direction of a circumference of the cam cylinder.

6. The imaging device according to claim 1, wherein the coupling portion has a detachment prevention portion that prevents the coupling portion from being detached from the optical member-holding member.

7. The imaging device according to claims 1, wherein an insertion guide portion that restricts a position of the second cam follower relative to the cam groove by actuation force applied by the actuation member to actuate the second cam follower to the cam cylinder.

8. The imaging device according to claim 1 further comprising a guide member that guides the optical member-holding member so as to be movable in the optical axis direction, wherein the optical member-holding member is guided by the guide member in a position out of an extension line of actuation force applied by the actuation member to actuate the coupling portion toward the drive portion.

9. A surveillance camera comprising the imaging device according to claim 1.
